(19) United States
(12) Patent Application Publication
(10) Pub. No.: US 2016/0113019 A1
(43) Pub. Date: Apr. 21, 2016

(54) TERMINAL AND COMMUNICATING METHOD THEREOF IN DEVICE TO DEVICE COMMUNICATON

(71) Applicant: Electronics and Telecommunications Research Institute, Daejeon (KR)

(72) Inventors: Dae Ik KIM, Daejeon (KR); JeeHyeon NA, Daejeon (KR); YEON SEUNG SHIN, Daejeon (KR)

(21) Appl. No.: 14/728,163

(22) Filed: Jun. 2, 2015

(30) Foreign Application Priority Data
Oct. 20, 2014 (KR) 10-2014-0142057

(51) Int. Cl. H04W 72/08; H04W 76/02; H04W 8/00; H04L 5/00; H04W 24/08

(52) U.S. Cl. CPC H04W 72/08; H04L 5/0055; H04W 24/08; H04W 8/005; H04W 76/023; H04W 88/08

(57) ABSTRACT

A second terminal which performs direct communication with a first terminal receives a signal for measuring a radio channel from the first terminal and calculates radio channel quality. Further, the second terminal calculates a data error rate using replay information indicating whether data are received and compensates for the radio channel quality depending on a data error rate. The second terminal reports the compensated radio channel quality to a base station and the base station uses the compensated radio channel quality to allocate resources used in direct communication.

### CROSS-REFERENCE TO RELATED APPLICATION

This application claims priority to and the benefit of Korean Patent Application No. 10-2014-0142057 filed in the Korean Intellectual Property Office on Oct. 20, 2014, the entire contents of which are incorporated herein by reference.

### BACKGROUND OF THE INVENTION

(a) Field of the Invention

The present invention relates to a terminal and a communication method thereof in device to device communication.

(b) Description of the Related Art

Recently, as communication devices such as a smart phone, a smart pad, and a tablet are rapidly propagated, various and new services have been provided. In a cellular mobile communication system, an amount of data traffic has been rapidly increased due to the propagation of the communication devices. Further, when machine to machine (M2M) using machine, such as communication between man and machine and communication between machines which are a new mobile market going beyond communication between men is activated, it is expected that a base station will be hardly fit for increasing traffic to be transmitted to the base station.

Therefore, as a method for improving performance of the existing mobile communication network at low cost, device to device (D2D) which is communication between cellular mobile communication devices based on proximity has been considered recently. A D2D communication technology using the cellular mobile communication system directly transmits data traffic between devices without passing through the base station. As a result, it is possible to reduce a usage of radio resources and the entire traffic amount of the cellular mobile communication network.

The proximity based D2D device has considered various scenarios. The D2D service is largely classified into a D2D service by a cellular mobile communication network control (that is, base station control) and a D2D service which is not subjected to the base station control for public safety in an area in which communication with the base station is impossible due to a natural disaster, and the like. The D2D service by the base station control may include a D2D service which provides service continuity by switching the cellular communication to the D2D communication when two terminals which are communicating with each other approach each other and a service (for example, D2D service, and the like which search for friends around a user and connect the user to the searched friends by the D2D) which provides direct communication between two terminals known to each other. Further, the D2D service by the base station control may include a service which provides direct communication between terminals without previously established relationship such as D2D local advertising service and D2D regional private broadcasting service.

In the case of the D2D communication by the cellular mobile communication network control (base station control), a terminal measures a radio channel (channel quality indicator (CQI)) with an opponent terminal for direct communication and reports the measured CQI to the base station. The base station figures out radio channel characteristics for communication between terminals based on the received CQI to determine a modulation & Coding scheme (MCS) and allocates resources for direct communication between terminals. Further, the terminal starts the communication between terminals based on the allocated resources and a hybrid automatic retransmit request (HARQ) retransmission to correct an error for data transmitted and received between the terminals is performed between the terminals.

Meanwhile, in the cellular communication between the base station and terminals, the MCS of the base station needs to be determined in comprehensive consideration of the CQI which generally measures a radio channel state between the terminals and the base station and an HARQ error rate which occurs during the data communication between the terminal and the base station. In other words, the base station compensates for the radio channel characteristics in consideration of the HARQ error rate to be able to maximize data processing.

However, in the direct communication between terminals, even though a terminal reports the CQI for an opponent terminal to the base station, the base station does not know the HARQ error rate which occurs due to the data communication between the terminals. That is, since the HARQ is made only between the terminals, the base station determines the MCS only based on the CQI which is reported by the terminal. Therefore, the channel characteristics are not accurately reflected at the time of determining the MCS and therefore the data processing rate may not be maximized.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for maximizing a data processing rate in a device to device communication method

An exemplary embodiment of the present invention provides a communication method of a second terminal which performs direct communication with a first terminal. The communication method includes: receiving a first signal for measuring a radio channel from the first terminal; calculating radio channel quality using the first signal; transmitting reply information indicating whether data are received from the second terminal to the first terminal through the direct communication; calculating an error rate of the data using the reply information; compensating for the calculated radio channel quality depending on the error rate; and reporting the compensated radio channel quality to a base station.

The compensating may include: compensating for the radio channel quality to be higher than the calculated radio channel quality, when the error rate is lower than a predetermined threshold; and compensating for the radio channel quality to be lower than the calculated radio channel quality, when the error rate is higher than the predetermined threshold.

The communication method may further include: reporting the calculated radio channel quality to the base station; receiving a first resource corresponding to the calculated radio channel quality from the base station; and receiving the data from the second terminal through the first resource.

The communication method may further include: receiving a second resource corresponding to the compensated radio channel quality from the base station; and receiving the data from the second terminal through the second resource

The communication method may further include: receiving a resource for receiving the first signal from the base station.

The reply information may be ACK or NACK.

The error rate may be reduced as the number of ACKs is increased and may be increased as the number of NACKs is increased.

Another exemplary embodiment of the present invention provides a terminal. A terminal includes: a radio frequency module receiving a signal for measuring a data and radio channel from an opponent terminal through direct communication, and

a processor connected to the radio frequency module and performing the direct communication with the opponent terminal, wherein the processor uses the signal to calculate radio channel quality, uses first information indicating whether data are received to calculate an error rate of hybrid automatic retransmit request (HARQ), and compensates for the calculated radio channel quality based on the calculated error rate.

The processor may compensate for the calculated radio channel quality to be higher when the error rate is lower than a predetermined threshold and compensates for the calculated radio channel quality to be lower when the error rate is higher than the predetermined threshold.

The wireless frequency module may transmit the compensated radio channel quality to a base station.

The terminal may be allocated with more resources from the base station as the error rate is increased.

The first information may be ACK or NACK.

The error rate may be reduced as the number of ACKs is increased and may be increased as the number of NACKs is increased.

Yet another exemplary embodiment of the present invention provides a communication method of a base station controlling direct communication between a first terminal and a second terminal. The communication method includes: receiving first radio channel quality which is radio channel quality between the first terminal and the second terminal from the first terminal; and allocating resources to the first and second terminals using the first radio channel quality, wherein the first radio channel quality is determined based on information indicating whether data transmitted between the first terminal and the second terminal are successfully received.

The allocating of the resources may include allocating more resources as a receiving success rate of the data is reduced.

The information may be ACK or NACK.

According to an exemplary embodiment of the present invention, it is possible to maximize the data communication processing rate between the terminals by reporting the radio channel state in consideration of the HARQ error rate at the time of reporting the radio channel state.

### BRIEF DESCRIPTION OF THE DRAWINGS

FIG. 1 is a diagram illustrating direct communication between terminals in a cellular mobile communication system according to an exemplary embodiment of the present invention.

FIG. 2 is a diagram illustrating a method for reporting a radio channel state in device to device communication according to an exemplary embodiment of the present invention.

FIG. 3 is a flow chart illustrating in more detail a procedure of reporting, by a terminal 210, radio channel quality in the device to device communication (direct communication between terminals) according to the exemplary embodiment of the present invention.

FIG. 4 is a diagram illustrating the terminal 210 according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, a terminal may be called a mobile terminal (MT), a mobile station (MS), an advanced mobile station (AMS), a high reliability mobile station (HR-MS), a subscriber station (SS), a portable subscriber station (PSS), an access terminal (AT), user equipment (UE), and the like and may include functions of all or some of the terminal, the MT, the MS, the AMS, the HR-MS, the SS, the PSS, the AT, the UE, and the like

Further, a base station (BS) may be called an advanced base station (ABS), a high reliability base station (HR-BS), a nodeB, an evolved node B (eNodeB), an access point (AP), a radio access station (RAS), a base transceiver station (BTS), a mobile multihop relay (MMR)-BS, a relay station (RS) serving as a base station, a high reliability relay station (HR-RS) serving as a base station, and the like and may also include functions of all or some of the ABS, the HR-BS, the nodeB, the eNodeB, the AP, the RAS, the BTS, the MMR-BS, the RS, the HR-RS, and the like.

Further, device to device (D2D) may be called direct communication between terminals. Throughout the following specification, terms of the device to device and the direct communication between the terminals may be mingled.

A terminal according to an exemplary embodiment of the present invention measures a radio channel state with an opponent terminal for direct communication and does not report CQI reported based on the measured result to a base station as it is. The terminal calculates an HARQ error rate which is directly transmitted and received between terminals for retransmission at the time of data communication between the terminals. The terminal compensates for a radio channel with a higher value than the measured CQI when the calculated HARQ error rate is low to report the CQI to the base station and compensates for a radio channel with a lower value than the measured CQI to report the CQI to the base station when the calculated HART error rate is high.

Hereinafter, a terminal and a communication method in device to device communication according to an exemplary embodiment of the present invention will be described in detail.

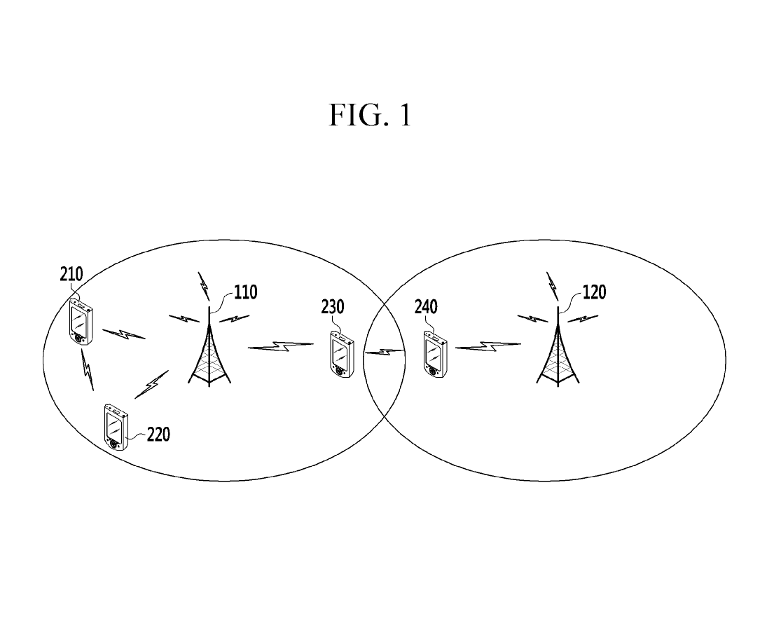

FIG. 1 is a diagram illustrating direct communication between terminals in a cellular mobile communication system according to an exemplary embodiment of the present invention.

As illustrated in FIG. 1, all the terminals 210 to 240 according to an exemplary embodiment of the present invention perform cellular communication with the base station. That is, the terminals 210 to 230 perform cellular communication with the base station 110 and a terminal 240 performs cellular communication with a base station 120. The base stations 110 and 120 perform all controls for direct communication between the terminals (D2D communication).

The direct communication between the terminals may be performed between the terminals belonging to the base station and may also be performed even between terminals belonging to different base stations. That is, the direct communication between the terminals may be performed between a terminal 210 and a terminal 220 and the direct communication between the terminals may be performed between a terminal 230 and a terminal 240. To be informed of the radio channel quality between the terminals which are the direct communication object between the terminals, the base stations 110 and 120 allocate resources (transmitting resource and receiving resource) for measuring a radio channel to each terminal. The terminals 210 to 240 measure the radio channel based on the allocated resources and report the measured result to the base stations 110 and 120. The base stations 110 and 120 allocate the resources for direct communication between terminals corresponding to the received channel quality and the terminals 210 to 240 perform the data communication using the allocated resources.

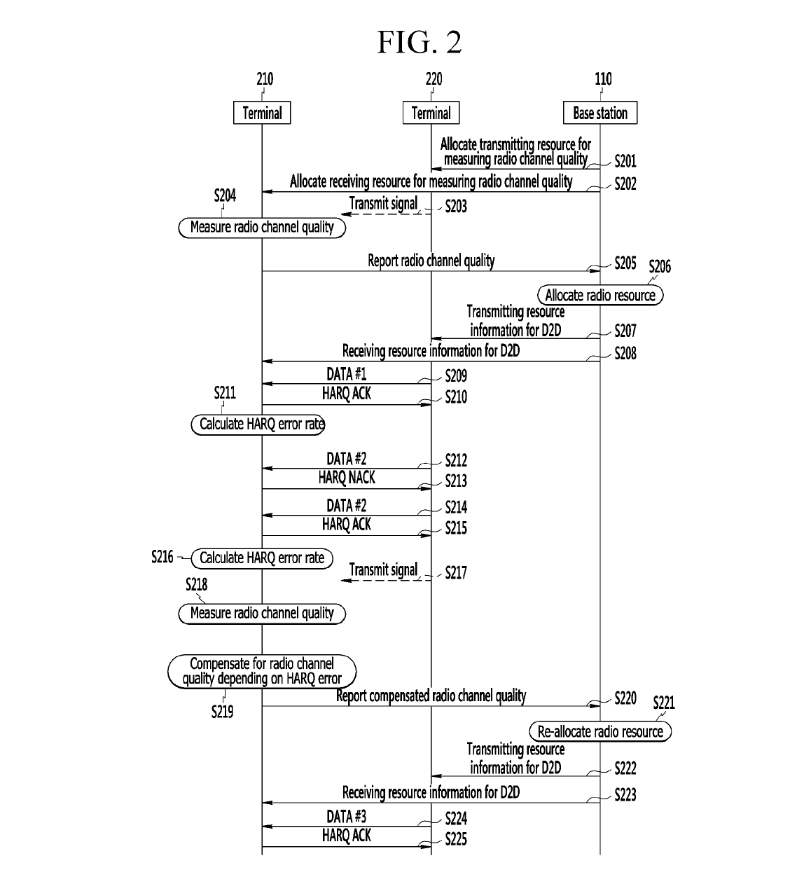

FIG. 2 is a diagram illustrating a method for reporting a radio channel state in device to device communication according to an exemplary embodiment of the present invention. For convenience of explanation, FIG. 2 will describe, for example, a case of the direct communication between the terminal 210 and the terminal 220 belonging to the base station 110, but the exemplary embodiment of the present invention may also be applied to the terminals 230 and 240 belonging to other base stations 110 and 120. Further, for convenience of explanation, FIG. 2 illustrates the case in which the terminal 220 transmits data to the terminal 210, but an opposite procedure thereto may be applied in the case in which the terminal 210 transmits data to the terminal 220.

As illustrated in FIG. 2, when the base station 110 knows the radio channel state between the two terminals 210 and 220 prior to starting the direct communication between the terminals, the base station 110 may determine a modulation & coding scheme (MCS) for data communication between the two terminals 210 and 220 and allocate resources.

The base station 110 allocates transmitting resources for measuring the radio channel quality to the terminal 220 and transmits the corresponding information to the terminal 220 (S201).

Further, the base station 110 allocates receiving resources for measuring the radio channel quality to the terminal 210 and transmits the corresponding information to the terminal 210 (S202). In this case, the information transmitted to the terminal 210 also includes transmitting resource information allocated to the terminal 220. As a result, the terminal 210 may measure the radio channel quality for the terminal 220.

By the above steps S201 and S202, the base station 110 may instruct the terminal 210 to measure the radio channel through which data are transmitted from the terminal 220 to the terminal 210.

The terminal 220 allocated with the transmitting resources for measuring the radio channel uses the allocated resources to transmit a signal for measuring the radio channel to the terminal 210 (S203). The terminal 220 may continuously transmit the signal for measuring the radio channel to the terminal 210.

The terminal 210 which is instructed to measure the radio channel measures the radio channel quality (CQI) for the terminal 220 based on the received signal (S204) and reports the measured radio channel quality (CQI) to the base station 205 (S205).

The base station 110 which is informed of the radio channel quality CQI from the terminal 210 figures out channel characteristics based on the reported radio channel quality CQI (S206). In the case, the base station 110 determines a modulation & coding scheme (MCS) through the chennel characteristiics and allocates a resource for direction communication between terminals (S206).

The base station 110 transmits the transmitting resource information for the direct communication between the terminals (D2D) to the terminal 220 (S207).

Further, the base station 110 transmits the receiving resource information for the direct communication between the terminals (D2D) to the terminal 210 (S208).

The terminal 220 transmits a first data DATA#1 based on the received transmitting resource information to the terminal 210 (S209). In this case, the terminal 210 receives the first data from the terminal 220 and transmits HARQ reply information (i.e., ACK or NACK) for the received data to the terminal 220 (S210). FIG. 2 illustrates an example in which the HARQ reply information is ACK but the HARQ reply information may be NACK.

Next, the terminal 210 according to the exemplary embodiment of the present invention uses the transmitted HARQ reply information (ACK or NACK) information to calculate the HARQ error rate (S211).

Steps S209, S210, and S211 are repeatedly performed on the next data DATA #2. The terminal 220 transmits the second data DATA #2 to the terminal 210 and the terminal 210 transmits the NACK as the HARQ reply information to the terminal 220 (S212, S213, and S214). Here, the HARQ reply information is the NACK, and therefore the terminal 220 again retransmits the second data DATA #2 (S214) and the terminal 210 transmits the ACK to the terminal 220 (S215).

Even during the data transmitting/receiving process, the terminal 210 continuously measures the radio channel quality for the terminal 220 (S217 and S218). Further, the terminal 210 periodically reports the measured channel quality to the base station 110. The terminal 210 continuously calculates the HARQ error rate (S216).

Here, as illustrated in FIG. 2, the HARQ NACK for the second data DATA #2 occurs and thus even though the radio channel quality deteriorates, the radio channel quality (i.e., radio channel quality measured in step S218) measured by the terminal 210 may be equal to the previous radio channel quality (i.e., radio channel quality measured in step S204). Under the above situations, the terminal 210 according to the exemplary embodiment of the present invention compensates for the measured radio channel quality (i.e., radio channel quality measured in step S218) with a lower value if it is determined that the HARQ error rate is equal to or more than a predetermined threshold to report channel quality as more deteriorating

In other words, the terminal 210 according to the exemplary embodiment of the present invention compensates for the radio channel quality depending on the HARQ error rate (S219) and reports the compensated radio channel quality to the base station 110 (S220).

When receiving the compensated radio channel quality, the base station 110 re-allocates the radio resources (S221). That is, when being informed of the lower channel quality from the terminal 210, the base station 110 determines new MCS and allocates more resources for the direct communication between the terminal 210 and the terminal 220.

The base station 110 transmits the radio resource information which is re-allocated in step S221 to the terminal 210 and the terminal 220, respectively (S222 and S223). That is, the base station 110 transmits the transmitting resource information for the direct communication between the re-allocated terminals to the terminal 220 and transmits the receiving resource information for the direct communication between the re-allocated terminals to the terminal 210.

According to the exemplary embodiment of the present invention, the terminal 210 reports the radio channel quality in consideration of the HARQ error rate and thus generate an error even lower than that of the second data DATA #2 when the terminal 210 transmits a third data DATA#3 to the terminal 220 (S224 and S225) occurs. As a result, the data communication between the terminals 210 and 220 may be more smoothly performed.

Meanwhile, when the HARQ NACK according to the data transmission is remarkably reduced and thus the radio channel state is good, the terminal 220 reports the higher radio channel quality in consideration of the HARQ. In this case, the base station may allocate the lower radio resources. As a result, it is possible to increase the efficiency of resources and improve the data processing rate.

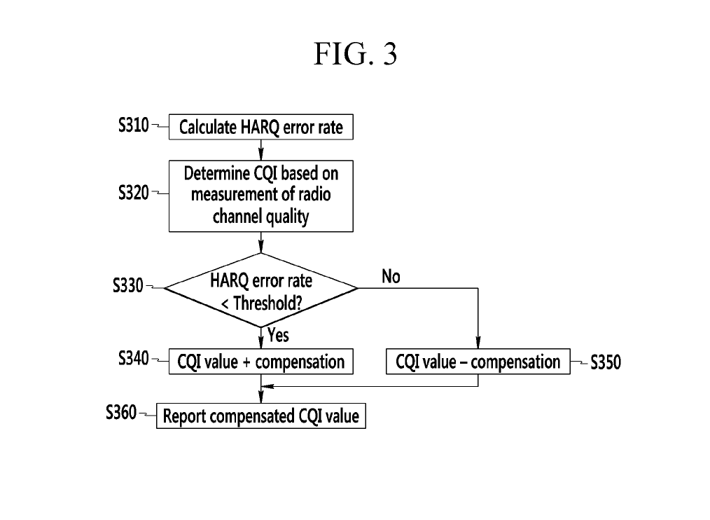

FIG. 3 is a flow chart illustrating in more detail a procedure of reporting, by a terminal 210, radio channel quality in the device to device communication (direct communication between terminals) according to the exemplary embodiment of the present invention.

As illustrated in FIG. 3, the terminal 210 according to the exemplary embodiment of the present invention continuously calculates the HARQ error rate which occurs due to the direct communication between terminals (S310). Here, the HARQ error rate may be calculated based on the ACK or NACK information which is transmitted from the terminal 210 to the terminal 220. When the terminal 210 transmits more NACK information, the HARQ error rate is increased and when the terminal 210 transmits more ACK information, the HARQ error rate is more reduced.

Next, the terminal 210 determines the CQI by measuring the radio channel quality (S320). That is, the terminal 210 determines the radio channel quality (CQI) based on the signal for measuring the radio channel received from the terminal 220. The measurement of the radio channel quality and the CQI determination by the terminal 210 may be periodically performed.

The terminal 210 determines whether the HARQ error rate measured in step S310 is lower than the predetermined threshold (S330).

In step S330, if it is determined that the HARQ error rate is lower than the predetermined threshold, the terminal 210 compensates for the CQI value with a value higher than the CQI value determined in step S320 (S340).

Further, in step S330, if it is determined that the HARQ error rate is higher than the predetermined threshold, the terminal 210 compensates for the CQI value with a value lower than the CQI value determined in step S320 (S350).

The terminal 210 reports the compensated CQI value to the base station 110 (S360). The base station 110 uses the compensated CQI value to re-allocate the resource for the direct communication between the terminals. That is, based on the report of the compensated channel quality, the base station 110 may perform the optimized resource allocation for the direct communication between the terminals and maximize the data processing rate of the direct communication between the terminals.

As described above, the terminal 210 according to the exemplary embodiment of the present invention does not directly report the radio channel quality (CQI) measured between the terminals to the base station 110 but continuously calculates the HARQ error rate in the direct communication between the terminals. Further, the terminal 210 compensates for the measured CQI to be higher when the HARQ error is lower than the predetermined threshold and then reports the measured result to the base station 110 and compensates for the measured CQI to be lower when the HARQ error rate is higher than the predetermined threshold and then reports the measured result to the base station 110. The base station 110 which is informed of the so compensated channel quality may allocate the resources for the direct communication between the terminals with optimal state and maximize the data processing rate of the direct communication between the terminals.

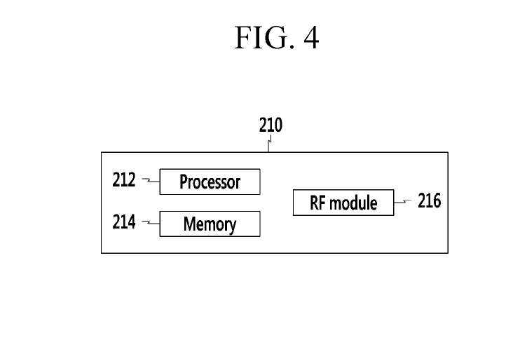

FIG. 4 is a diagram illustrating the terminal 210 according to the exemplary embodiment of the present invention.

Referring to FIG. 4, the terminal 210 includes a processor 212, a memory 214, and a radios frequency (RF) module 216.

The processor 212 may be configured to implement the procedures and the methods which are described with reference to FIGS. 2 and 3. That is, the processor 212 according to the exemplary embodiment of the present invention calculates the HARQ error rate and compensates for the CQI in consideration of the calculated HAQR error rate.

The memory 214 is connected to the processor 212 and stores various information associated with the operation of the processor 212.

The RF module 216 is connected to the processor 212 to transmit and receive a radio signal. The RF module 216 according to the exemplary embodiment of the present invention transmits the compensated CQI to the base station 110.

Further, the terminal 210 may have a single antenna or a multiple antenna.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A communication method of a second terminal which performs direct communication with a first terminal, comprising:
receiving a first signal for measuring a radio channel from the first terminal;
calculating radio channel quality using the first signal;
transmitting reply information indicating whether data are received from the second terminal to the first terminal through the direct communication;
calculating an error rate of the data using the reply information;
compensating for the calculated radio channel quality depending on the error rate; and
reporting the compensated radio channel quality to a base station.

2. The communication method of claim 1, wherein the compensating includes:
compensating for the radio channel quality to be higher than the calculated radio channel quality, when the error rate is lower than a predetermined threshold; and
compensating for the radio channel quality to be lower than the calculated radio channel quality, when the error rate is higher than the predetermined threshold.

3. The communication method of claim 1, further comprising:
reporting the calculated radio channel quality to the base station;
receiving a first resource corresponding to the calculated radio channel quality from the base station; and
receiving the data from the second terminal through the first resource.

4. The communication method of claim 3, further comprising:
receiving a second resource corresponding to the compensated radio channel quality from the base station; and
receiving the data from the second terminal through the second resource.

5. The communication method of claim 1, further comprising:
receiving a resource for receiving the first signal from the base station.

6. The communication method of claim 1, wherein:
the reply information is ACK or NACK.

7. The communication method of claim 6, wherein the error rate is reduced as the number of ACKs is increased and is increased as the number of NACKs is increased.

8. A terminal, comprising:
a radio frequency module receiving a signal for measuring a data and radio channel from an opponent terminal through direct communication; and
a processor connected to the radio frequency module and performing the direct communication with the opponent terminal,
wherein the processor uses the signal to calculate radio channel quality, uses first information indicating whether data are received to calculate an error rate of hybrid automatic retransmit request (HARQ), and compensates for the calculated radio channel quality based on the calculated error rate.

9. The terminal of claim 8, wherein the processor compensates for the calculated radio channel quality to be higher when the error rate is lower than a predetermined threshold and compensates for the calculated radio channel quality to be lower when the error rate is higher than the predetermined threshold.

10. The terminal of claim 8, wherein the wireless frequency module transmits the compensated radio channel quality to a base station.

11. The terminal of claim 10, wherein the terminal is allocated with more resources from the base station as the error rate is increased.

12. The terminal of claim 8, wherein the first information is ACK or NACK.

13. The terminal of claim 12, wherein the error rate is reduced as the number of ACKs is increased and is increased as the number of NACKs is increased.

14. A communication method of a base station controlling direct communication between a first terminal and a second terminal, comprising:
receiving a first radio channel quality which is radio channel quality between the first terminal and the second terminal from the first terminal; and
allocating resources to the first and second terminals using the first radio channel quality,
wherein the first radio channel quality is determined based on information indicating whether data transmitted between the first terminal and the second terminal are successfully received.

15. The communication method of claim 14, wherein the allocating of the resources includes allocating more resources as a receiving success rate of the data is reduced.

16. The communication method of claim 15, wherein the information is ACK or NACK.
